(19) United States
(12) Patent Application Publication
(10) Pub. No.: US 2007/0092719 A1
(43) Pub. Date: Apr. 26, 2007

(54) Coated transparent plastic film and method for the production thereof

(75) Inventor: Axel Burmeister, Buchholz (DE)

Correspondence Address: NORRIS, MCLAUGHLIN & MARCUS, PA, 875 THIRD AVENUE, 18TH FLOOR, NEW YORK, NY, 10022, US

(73) Assignee: Tesa AG, Hamburg (DE)

(21) Appl. No.: 10/530,819

(22) PCT Filed: Feb. 24, 2003
(86) PCT No.: PCT/EP03/01834

§ 371 Date: Nov. 13, 2006

(30) Foreign Application Priority Data
Mar. 13, 2002 (DE) 102 10 990.7

(51) Int. Cl. B05B 5/00; B32B 7/12

(52) U.S. Cl. 428/343; 427/160

(57) ABSTRACT

The invention relates to a coated transparent plastic film wherein the thickness of the at least one layer applied to the plastic film varies locally for the representation of an image.

The invention relates to a coated transparent plastic film and to a method of producing coated plastic films having at least one layer.

Coated plastic films are used diversely: for example, as self-adhesive film strips, large-area films, or labels.

Also known is the printing of films with colored patterns.

Also known is the application, in particular to sheets of paper, of watermarks. The watermark is generally a pictorial or textural mark which is clearly visible only when viewed in transmitted light, with the sheet of paper held against the light. A watermark is produced by, for example, reducing the amount of paper slurry at the watermark sites when manufacturing a sheet of paper. It is also possible for the moist paper web to be compressed locally, in order to apply watermarks, in particular, in the case of continuous rolls of paper manufactured using a paper machine.

It was an object of the invention to provide a coated transparent plastic film which carries an image as, for example, a security feature.

This object is achieved in accordance with the invention by locally varying the thickness of a layer applied to the plastic film in order to depict an image.

By means of the layers of composition, differing in height, shades or degrees of lightness which vary in strength are achieved, and are used in order to depict an image.

The image is simple and cheap to produce in mass production and can serve in particular as a safety feature.

The at least one layer, varying locally in its thickness, preferably has polymers which are or have been colored, so that the differences in layer thickness produce shades differing in strength, which can be perceived through the transparent plastic sheet.

The polymers used to form the layer may either be colored themselves or may be colored by introduction of colorant. As an alternative to this the polymers may also be blended with a colorant.

It is particularly advantageous for the layer to be composed of a polymer-containing self-adhesive composition, so that the coated transparent plastic film can be adhered to a substrate. The image produced by the varying layer thickness then becomes visible, for example, as a result of the contrast with the attachment surface, like a watermark.

It is particularly advantageous if the self-adhesive layer is designed such that its structure is destroyed when the layer is detached from the attachment surface itself. In this way the watermark acts as a security feature, since counterfeiting or subsequent alteration requiring detachment of the plastic film from the attachment surface becomes immediately visible.

The object is further achieved by the generic method, in which at least one layer is applied to the transparent plastic film with a locally varying layer thickness in order to depict an image by means of the varying layer thickness.

For the mass production of plastic films of the invention it is advantageous, however, to apply the at least one layer to the plastic film by means of a roll-coating installation. In this case the relief of the desired depiction is applied to the surface of at least one roll, it being possible for the relief to be produced by means for example of etching, adhesive attachment of gravure or flexographic printing plates, laser ablation coating, lithographic techniques, or the like. The plastic film is wound around one of the rolls and the coating material is introduced into the space between adjoining rolls. In this way, even at low layer thicknesses in the region of 10 μm, controlled layer-thickness variations can be produced with an application of adhesive at a rate in the range from about 2 g/m³ to 15 g/m³.

The invention is illustrated below with reference to the attached drawings.

In these drawings:

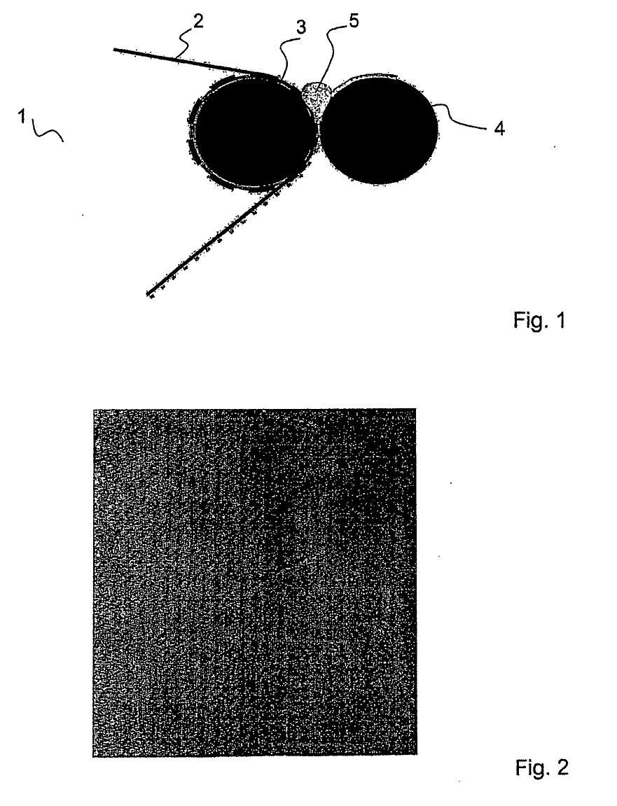

FIG. 1—shows a schematic block diagram of a two-roll coating installation for producing a coated transparent plastic film of the invention;

FIG. 2—shows a plan view of a plastic film of the invention;

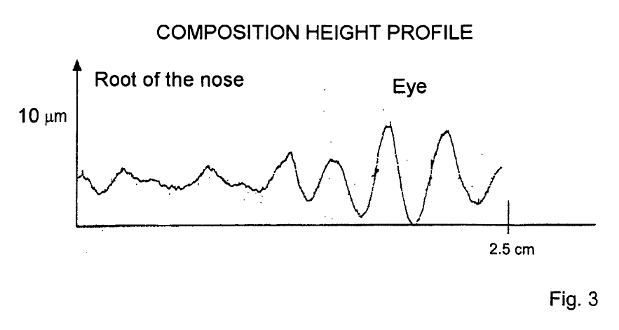

FIG. 3—shows a diagram of the composition height profile of the plastic film from FIG. 2.

FIG. 1 shows a two-roll coating installation 1 for applying a layer, varying in its thickness locally in order to depict an image, to a transparent plastic film 2, in the schematic side elevation. A first roll 3 has been provided with a printing plate of the type known fundamentally from printing machines. Preference is given to using a halftone printing plate. The printing plate used carries the at least one depiction to be imaged, or watermark, and is wrapped with a transparent plastic film 2. The plastic film 2 used is, for example, a PTE film having a thickness of about 35 μm to 50 μm. Another roll, 4, is stationary and is heated at about 80° C.

The polymer-containing coating composition 5 is conveyed via a feed device 6 into the nip between the two rolls 3 and 4.

After the coating pass, the plastic film 2 can be lined with a release paper or release film and wound up to form a bale.

FIG. 2 shows a section of a coated transparent plastic film 2 produced in this way, which has an average adhesive application rate of approximately 10 g/m³. As a result of the printing plate, the applied adhesive is distributed locally, during production, in the range from 2 g/m³ to 15 g/m³, so that the desired image is imaged as a gray-stage picture or color picture when the plastic film 2 is bonded to a dark substrate.

FIG. 3 shows the composition height profile of a selected vertical from the section, depicted in FIG. 2, of the coated transparent plastic film 2. In the left-hand half of the diagram the thickness of the applied layer varies only a little, in order to depict the root of the nose. In the right-hand half of the diagram, on the other hand, a sharp variation in layer thickness, for the purpose of depicting an eye, is visible.

The layer applied to the plastic film 2 is, for example, a natural rubber adhesive composition.

The natural rubber adhesive composition is composed by way of example of 40% CV 50, 19% chalk, 30% resin, 1% ASM and 10% TiO₂. The natural rubber adhesive composition is premixed in a commercially customary internal mixer (1 kg mixing volume) with a third of the resin at 150° C. for 3 minutes. In a second mixing operation the remaining resin is completed with the premixed composition in a Z-arm compounder (mixing volume 1 kg for example) at 80° C. for 15 minutes. The natural rubber adhesive composition thus produced is then introduced into the roll nip of the two-roll coating installation.

Other production methods, however, are also conceivable, such as dispersion printing or hotmelt screen printing, for example.

As compositions for forming the layer it is possible in particular to use adhesive compositions having a strong intrinsic coloration, or compositions blended with a colorant. Colorants which can be used are, in particular, all commercially customary colorants suitable for polymers, but particularly TiO₂ and carbon blacks, owing to their high hiding power.

Also of particular advantage, however, are pigments, such as ultraviolet pigments, for example, with which images are obtained which are invisible in daylight but can be seen by means of an ultraviolet light source.

1. A coated transparent plastic film comprising a plastic film and at least one layer applied to the plastic film, wherein the at least one layer varies locally in thickness in order to depict an image.

2. The coated transparent plastic film of claim 1, wherein the at least one layer comprises polymers which are or have been colored.

3. The coated transparent plastic film of claim 2, wherein the layer is formed from blended polymers.

4. The coated transparent plastic film according to claim 1, wherein at least one layer is self-adhesive.

5. The coated transparent plastic film of claim 4, wherein the self-adhesive layer is designed such that its structure is destroyed when the layer is detached from an attachment surface.

6. The coated transparent plastic film according to claim 1, wherein the layer comprises ultraviolet pigments.

7. A method of producing a coated transparent plastic film according to claim 1, said method comprising applying to the transparent plastic film the at least one layer with a locally varying layer thickness in order to depict an image by means of the varying layer thickness.

8. The method of claim 7, which further comprises coating the plastic film with polymers which are or have been colored, or with blends thereof.

9. The method of claim 7, wherein the at least one layer is self-adhesive.
